(19) United States
(12) Patent Application Publication
(10) Pub. No.: US 2007/0058756 A1
(43) Pub. Date: Mar. 15, 2007

(54) Reduced complexity soft output demapping

(76) Inventors: Ravishankar H. Mahadevappa, Irvine, CA (US); Stephan ten Brink, Irvine, CA (US)

Correspondence Address: CHRISTIE, PARKER & HALE, LLP, PO BOX 7068, PASADENA, CA, 91109-7068, US

(21) Appl. No.: 11/490,851

(22) Filed: Jul. 21, 2006

Related U.S. Application Data
(60) Provisional application No. 60/701,619, filed on Jul. 21, 2005.

(51) Int. Cl. H04L 27/06

(52) U.S. Cl. 375/340

(57) ABSTRACT

Method and system for extracting soft estimates of DCM or 16-QAM modulated symbols that are received from a noisy channel. Optimal soft demapping rules are approximated using equations that are division-free and eliminate the need for implementing exponential and logarithmic functions that are inconvenient for hardware implementation.

### CROSS-REFERENCE TO RELATED APPLICATION

This application claims priority to U.S. Provisional Patent Application No. 60/701,619 filed on Jul. 21, 2005, the entire contents of which are incorporated herein by reference.

### BACKGROUND OF THE INVENTION

The present invention relates generally to soft output demapping and more particularly to soft output demapping in a receiver of orthogonal frequency division complexed (OFDM) signals in an ultrawideband (UWB) communication system.

OFDM symbol structure and frequency hopping patterns are disclosed in Multiband OFDM Physical Layer Specification, Release 1.0, Jan. 14, 2005 which is incorporated by this reference.

At a transmitter of a UWB communication system for OFDM signals, a bit stream of data that is intended for transmission may be encoded, interleaved and mapped. At a receiver of this transmission, the data is demapped, deinterleaved and decoded. Decoding generally includes bit correction, or more generally symbol correction, to account for transmission and reception errors, particularly those induced by a communication channel. Thus, bits (or symbols) provided to a decoder may be considered estimated bits (or symbols), with the decoder providing corrected bits or symbols. For simplicity only referring to bits, in some instances the decoder may be provided what is sometimes referred to as hard bits, for example, 0s and 1s. Alternatively, the decoder may be provided what is sometimes referred to as soft bits, for example, values ranging from 0 to 1, with the distance of the magnitude from a midpoint between the two extremes indicating a level of confidence in the value of the bit. Generally, decoding using soft bits, namely soft estimates of bit values, provides for increased correctness in decoding.

Mapping is some times referred to as modulation. Various types of mapping schemes may be used that convey data by changing, or modulating, the amplitude, phase, or frequency of a reference signal that is being used as the carrier wave. Any digital modulation scheme uses a finite number of distinct signals to represent digital data. In the case of phase-shift key (PSK) modulation, for example, a finite number of phases are used. Each of these phases is assigned a unique pattern of binary bits. Each pattern of bits forms the symbol that is represented by the particular phase. The demapper or demodulator, which is designed specifically for the symbol-set used by the modulator, determines the phase of the received signal and maps it back to the symbol it represents, thus recovering the original data.

Quadrature phase-shift keying (QPSK) and dual carrier modulation (DCM) are two types of modulation or mapping. DCM corresponds to two shifted QPSK constellations. The demapping schemes recover the encoded bits or develop estimates for the encoded bits. When the data is transmitted over a noisy channel, for example a channel introducing additive white Gaussian noise, then the symbols need to be estimated from noisy received symbols. Equations often used for calculating estimates of the transmitted bits, however, may involve exponential and logarithmic functions which may not be convenient for hardware implementation.

### SUMMARY OF THE INVENTION

In one aspect, the invention provides a method of determining soft bit estimates for transmitted symbols, comprising receiving a symbol over a communication channel; and receiving an estimate of a channel coefficient for the communication channel; determining an estimated value for bits of the received symbol by performing only additive and/or multiplicative operations using the received symbol and the estimate of the channel coefficient.

In another aspect, the invention comprises the invention comprises a demapper for extracting soft information regarding transmitted bits per each DCM symbol transmitted over a noisy channel from received noisy complex symbols, the demapper comprising demapper circuitry for developing estimates of complex channel coefficients, and estimates of the transmitted bits based on the estimates of complex channel coefficients and the received noisy complex symbols, wherein the demapper circuitry implements division-free operations, and wherein an estimate of the DCM symbol is obtained from the estimates of the transmitted bits.

In another aspect, the invention comprises a demapper for extracting soft information regarding transmitted bits per each 16-QAM symbol transmitted over a noisy channel from received noisy complex symbols, the demapper comprising demapper circuitry for developing estimates of complex channel coefficients, and estimates of the transmitted bits based on the complex channel coefficients and the received noisy complex symbols, wherein the demapper circuitry implements division-free operations, and wherein an estimate of the 16-QAM symbol is obtained from the estimates of the transmitted bits.

These and other aspects of the invention are more fully comprehended on review of this disclosure, including the figures which are part thereof.

### BRIEF DESCRIPTION OF THE DRAWINGS

FIG. 1 is a block diagram of a transmitter and a receiver according to the embodiments of the present invention.

FIG. 2 is a flow chart of soft demapping process according to the embodiments of the present invention.

FIG. 3A and FIG. 3B show constellations of two 16 Quadrature Amplitude modulated (QAM) symbols corresponding to one dual-carrier modulated (DCM) symbol that includes four bits of data.

FIG. 4 shows a 16-QAM constellation and assignment of bits from data streams of FIG. 1 according to the embodiments of the present invention.

### DETAILED DESCRIPTION OF THE INVENTION

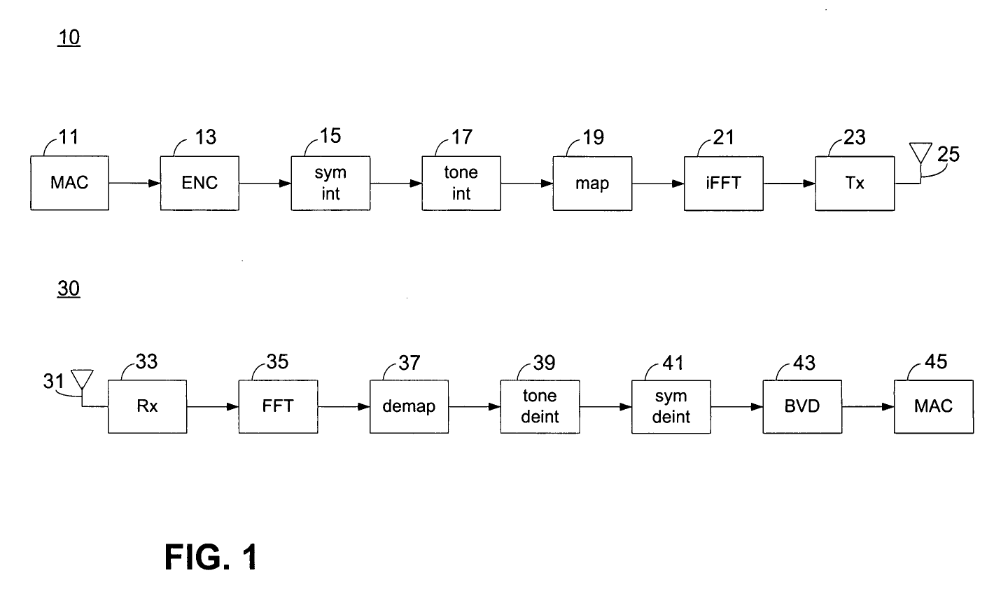

FIG. 1 is a block diagram of a transmitter 10 and a receiver 30 in accordance with aspects of the invention. The transmitter 10 includes a media access control (MAC) 11 coupled to an encoder 13, a symbol interleaver 15, a tone interleaver 17, a mappers 19, an iFFT block 21 and an analog RF block 23, all in series. The analog RF block 23 transmits the data over a transmitter antenna 25. A stream of data is provided by the MAC 11. The MAC 11 may provide data in the form of bytes or words. The encoder 13 operates on the data. The symbol interleaver 15 receives the data from the encoder 13 and interleaves the received data. The tone interleaver 17 receives the data stream from the symbol interleaver 15. The mapper 19 receives the tone interleaved data and maps or modulates the interleaved data according to a mapping scheme. The mapper may map data using various modulation schemes such as a QPSK modulation scheme, a DCM scheme, or a 16 QAM constellation, with the selected scheme depending on an information rate selected by the MAC 11.

For higher data rates, when data is received from the MAC over a two byte interface, a high byte is encoded by a first encoder and the low byte is encoded by a second encoder. One symbol interleaver, and dual tone interleavers, would be associated with each encoder. Two mappers each separately map interleaved encoded bits associated with the two encoders.

The iFFT block 21 receives the symbols from the mapper 19 which transforms the symbols from the frequency domain back to the time domain. The analog RF block 23 receives the time domain symbols from the iFFT block 21 for transmission via one or more antennas 25.

When transmission is performed with multiple antennas, such as two antennas, the antennas may operate in a cross-polarized configuration each possibly with associated up-conversion circuitry. Therefore, if a second transmitter antenna is driven by the same digital baseband signal, the two transmitter antennas may radiate in two spatial polarizations. The input signal to the analog RF of the transmitter may be modified in phase and amplitude (in digital baseband) by a constant complex multiplier for fine-tuning with regard to a particular antenna or installation geometry.

The receiver 30 of FIG. 1 may receive signals using a single antenna 31 or multiple receive antennas. Each receive antenna is associated with a corresponding receiver circuitry and signal processor which receive the signal from the antenna 31. The receiver 30 further includes a receiver analog RF block 33 associated with the receive antennas. The receiver analog RF block may include signal reception circuitry and a signal processor. The signal processor for the antenna performs, for example, packet detection, frame synchronization, and, in various embodiments, processing associated with control of automatic gain control features of the receiver. The signal processor provides one or more parallel data streams, which are transformed from the time domain to the frequency domain by a FFT block 35 corresponding to one receiver analog RF block. More FFT blocks may be used if other receiver analog RF blocks are included.

A MRC block (not shown) may be located after the FFT block and before a demappers 37. When the outputs of the FFT blocks include either even or odd symbols, outputs of FFT blocks providing even symbols are received by a first MRC block and outputs of FFT blocks providing odd symbols are received by a second MRC block. When more than one antenna is used, each MRC block receives some of its input from one of the antennas and the rest from the other antennas. When MRC blocks are used, the outputs of each MRC block is received by a demapper. The inputs from the FFT blocks to the MRC blocks are arranged such that the output of each pair of FFT blocks, coupled to the same receiver block, is received by a separate corresponding demapper through the MRC blocks.

A demapper 37 may be coupled to the FFT block 35 and receives the Fourier transforms of the received data stream that are provided by the FFT block. The demapper 37 demaps data, for example in accordance with a 16-QAM constellation. Preferably, the demapper provides soft estimates as the demapped data. One or more tone interleavers 39 receive the demapped data from the demapper 37. The tone interleaver is coupled to a symbol interleaver 41. In various embodiments where more than one demapper is used, a portion of each demapper output may be received by a separate tone interleaver associated with a symbol deinterleaver and another portion of each demapper output may be received by a different tone interleaver that is associated with a different symbol deinterleaver.

When more than one symbol deinterleavers 41 are used, each may be associated with a decoder, with possibly each symbol deinterleaver associated with a separate corresponding decoder. In FIG. 1, the symbol deinterleaver 41 is associated with a Viterbi decoder 43. The output of the Viterbi decoder 43 is provided to a MAC 45. Different modulation (mapping) may be implemented by the mappers/demappers and different codes rates may be implemented by the encoders/decoders, for example, based on a selected information rate.

Some embodiments of the transmitter 10 and receiver 30 of FIG. 1 may be used as a multiband orthogonal frequency division multiplexed (OFDM) transmitter and receiver in an ultrawideband (UWB) communication system according to the embodiments of the present invention.

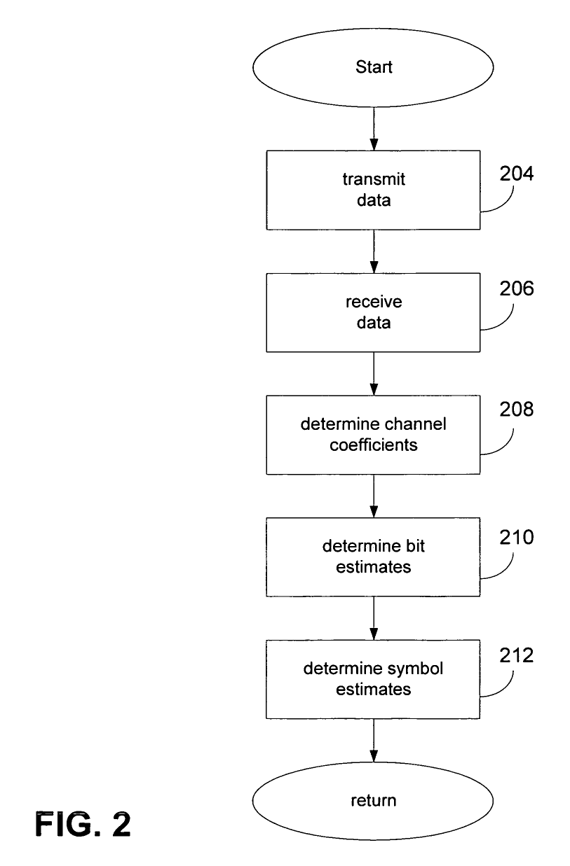

FIG. 2 is a flow chart of soft demapping process according to the embodiments of the present invention. Data is transmitted in block 204 from a transmitter to a receiver through a potentially noisy channel. The transmitted data includes bits that form a symbol according to a mapping or modulation scheme used at the transmitter. The transmitted data is received in block 206 at the receiver in the form of noisy complex symbols. Channel coefficients that may be complex are determined in block 208. The channel coefficients may be estimated from a channel estimation sequence of the received data packets. Next, estimates of the transmitted bits of data are determined in block 210. The channel coefficients and the received noisy symbols may be used to derive the estimates of the transmitted bits of data. Finally, estimates of the symbols transmitted are determined in block 212. The estimates of the transmitted bits may be used to in turn yield estimates of the transmitted symbols.

In some embodiments, portions of the process shown in FIG. 2, including the determining of channel coefficients 208, the determining of the bit estimates 210, and the final estimation of the symbols transmitted 212 are performed by the demapper 37 of FIG. 1.

At the transmitter, binary information (bits) are grouped and mapped onto constellation symbols. Two different modulation schemes that may be used, for example, include quadrature phase shift keying (QPSK) and dual-carrier modulation (DCM). For the QPSK mapping scheme, 2 bits are grouped and mapped onto 4 signal points. For the DCM mapping scheme, 4 bits are grouped and mapped onto two 16-QAM constellations, effectively implementing a QPSK modulation combined with a rate ½ repetition code in the constellation space where each of the 16 combinations are represented by two combinations of 16-QAM constellation points. In some embodiments, where one OFDM symbol is composed of 128 subcarriers, the two 16-QAM symbols representing one DCM symbol are on two different subcarriers of the same OFDM symbol.

In soft output demapping for DCM, a soft value is computed for each of the 4 bits per DCM symbol, i.e., per the two 16-QAM symbols on the two subcarriers. The sign of the soft value indicates the binary decision whether a 0 or a 1 was transmitted. The absolute value of the soft value indicates how reliable the decision is. For example, values close to zero are regarded as unreliable.

One processing chain at the transmitter may include one encoder coupled to one mapper. One processing chain at the receiver may include one demapper coupled to one or two decoders. Preferably, for lower data rates, a QPSK modulation or mapping scheme is used. The lower data rates may use one processing chain at the transmitter and one processing chain at the receiver. One mapper may be used for these rate groups at the transmitter and one demapper at the receiver. For example, for data streams at data rates of 53.3, 80, 106.7, 160, or 200 Mbps, the QPSK modulation and one processing chain including one encoder and one mapper at the transmitter and one demapper and one decoder at the receiver are used. For relatively higher data rates, the DCM mapping scheme may be used. The relatively higher data rates may still use only one processing chain at the transmitter and one processing chain at the receiver. For example, for data streams at data rates of 320, 400, 480, or 512 Mbps, the DCM modulation and one processing chain including one encoder and one mapper at the transmitter may be used while the receiver may include one demapper and two decoders within one processing chain. For even higher data rates, a second processing chain is activated at the transmitter. The second processing chain begins with a second encoder and includes a second mapper. When the second processing chain is also active, then the 16-QAM modulation is used for mapping of the encoded and interleaved bits arriving at the two mappers. In the 16-QAM mapping, two bits on the I-channel, constituting the real part of the complex constellation symbol, come from the first stream and two bits on the Q-channel, constituting the imaginary part of the complex constellation symbol, come from the second stream. For example, for data streams at data rates of 640, 800, 960, or 1024 Mbps, the 16 QAM modulation and two processing chains including two encoders and two mappers at the transmitter may be used while the receiver uses two processing chains each including one demapper and two decoders.

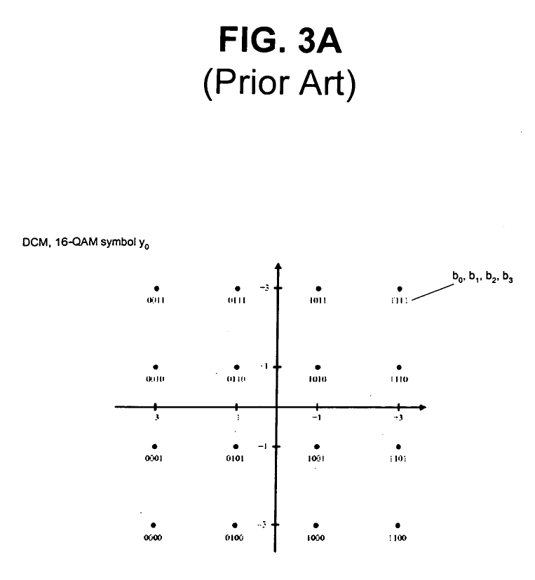

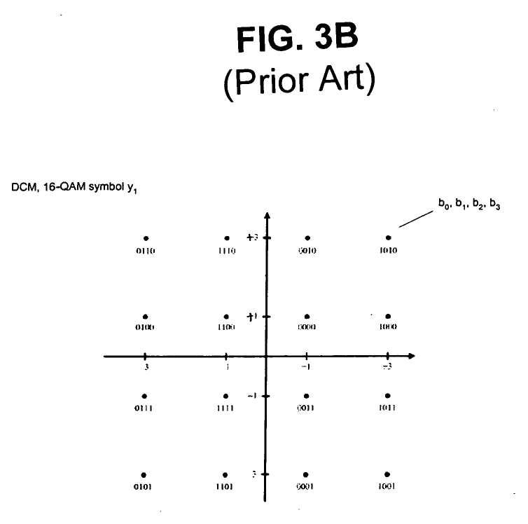

FIG. 3A and FIG. 3B show constellations of two 16-QAM symbols corresponding to one DCM symbol that includes four bits of data.

In some embodiments, four bits bᵢε{0,1}i=0, . . . , 3 are mapped onto two 16-QAM symbols y₀ and y₁. The two 16-QAM symbols y₀ and y1 together form one DCM symbol.

The four bits of data that are to be transmitted include b₀, b₁, b₂, and b₃. Each of the four bits may be 0 or 1 such that the sixteen combinations of 0000, 0001, 0010, 0011, 0100, 0101, 0110, 0111, 1000, 1001, 1010, 1011, 1100, 1101, 1110, and 1111 may result from different permutations of the 0 bit and the 1 bit.

The four bits b₀, b₁, b₂, b₃ are mapped onto the two 16-QAM symbols y₀ and y₁, for example, according to the following rule:

$$[ \begin{matrix}{y}_{0} \\ {y}_{1}\end{matrix} ] = \frac{1}{\sqrt{10}} [ \begin{matrix}2 & 1 \\ 1 & - 2\end{matrix} ] \cdot [ \begin{matrix}{x}_{0} + j {x}_{1} \\ {x}_{2} + j {x}_{3}\end{matrix} ]$$

$$Where {x}_{i} = 2 {b}_{i} - 1 ; {x}_{i} ∈ \{ - 1 , + 1 \} ; i = 0 , … , 3.$$

As a result, x₀=2b₀−1, x₁=2b₁−1, x₂=2b₂−1, and x₃=2b₃−1. Considering that each bᵢ can take only two values of 0 or 1, the resulting xᵢ will take a value of either 1 or −1. For example, if b₀=0, then x₀=−1 and if b₀=1, then x₀=1. The same relationship holds for the remaining values of xᵢ such that x₁, x₂, and x₃ will each take a value of either 1 or −1.

According to the above matrix multiplication:
y₀=(1/√10)*[2(x₀+jx₁)+1(x₂+jx₃)]=(1/√10)*[(2x₀+x₂)+j(2x₁+x₃)], and
y₁=(1/√10)*[1(x₀+jx₁)−2(x₂+jx₃)]=(1/√10)*[(x₀−2x₂)+j(x₁−2x₃)].

Because x₀, x₁, x₂, and x₃ take only values of 1 and −1, then the real and complex portions of y₀ and y₁ each take values that are multiples of −3, −1, +1, and +3. The two resulting complex 16-QAM symbols, y₀ and y₁, are depicted in FIGS. 3A and 3B, respectively. In these figures, the amplitudes are multiplied by √10 to yield integer values −3, −1, +1, and +3.

The constellation corresponding to the first 16-QAM symbol y₀ may be Gray-coded such that each two neighboring groups of four bits are different in one bit only. The constellation corresponding to the second 16-QAM symbol y₁ shown in FIG. 3B is not Gray-coded.

To extract soft information values for the four bits per DCM symbol, that includes the two 16-QAM symbols, the log-likelihood ratio value based on posteriori probabilities (Gaussian hypothesis) may be computed for each bit. This generally involves exponential and logarithmic functions which are inconvenient for hardware implementation.

For each one DCM symbol, including the two 16-QAM symbols y₀ and y₁, the received noisy complex symbols from the channel are:
\tilde{y}₀=h₀y₀+n₀, \tilde{y}₁=h₁y₁+n₁,

where h₀ and h₁ are the complex channel coefficients and n₀ and n₁ are the additive noise. Estimates of the four bits b₀, b₁, b₂, and b₃ of the two DCM symbols y₀ and y₁, are derived from the noisy complex symbols \tilde{y}₀ and \tilde{y}₁. Embodiments of the invention include methods and circuitry (for example as part of a demapper) for obtaining the soft estimates for b₀, b₁, b₂, and b₃, using the following approximations of the optimal soft demapping rules:
L₀=2z_{0,re}+|z_{1,re}−c|−|z_{1,re}+c| as an estimate for bit b₀,
L₁=2z_{0,im}+|z_{1,im}−c|−|z_{1,im}+c| as an estimate for bit b₁,
L₂=2z_{1,re}+|z_{0,re}−c|−|z_{0,re}+c| as an estimate for bit b₂, and
L₃=2z_{1,im}+|z_{0,im}−c|−|z_{0,im}+c| as an estimate for bit b₃,
where
z₀=(2\tilde{h}₀*\tilde{y}₀+\tilde{h}₁*\tilde{y}₁)/\sqrt{10}=z_{0,re}+jz_{0,im}
z₁=(\tilde{h}₀*\tilde{y}₀−2\tilde{h}₁*\tilde{y}₁)/\sqrt{10}=z_{1,re}+jz_{1,im}
where c is a constant according to the relationship:

$$c = \frac{{\vert {\tilde{h}}_{0} \vert}^{2} - {\vert {\tilde{h}}_{1} \vert}^{2}}{5} .$$

In the above equations, \tilde{h}₀, \tilde{h}₁ are estimates of the complex channel coefficients h₀, h₁ as determined by the channel estimation unit based on the channel estimation sequence of the packet preamble, \tilde{h}₀*,\tilde{h}₁* are the complex conjugates of \tilde{h}₀,\tilde{h}₁, and the notation |x| denotes the absolute value of x for real x, and the magnitude of x for complex x. Other embodiments of the invention include systems implementing the above approximations for the bits in circuitry, for example in demap circuitry of a demapper.

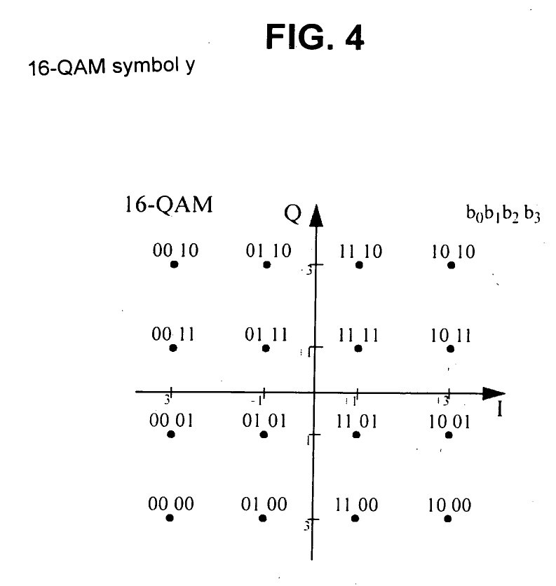

FIG. 4 shows a 16-QAM constellation and assignment of bits from data streams of FIG. 1 according to the embodiments of the present invention.

As explained above, for high data rates a 16-QAM modulation scheme may be used instead of the DCM modulation scheme. FIG. 4 shows the 16-QAM constellation and assignment of bits from two streams of data. The first two bits b₀ and b₁ are used from a first encoder for a first stream and the second two bits b₂ and b₃ are used from a second encoder for a second stream. In FIG. 4, the amplitudes of the symbols are multiplied by sqrt(10) to obtain integer values −3, −1, +1, and +3.

The four bits bᵢε{0,1}, i=0, . . . , 3 or b₀, b₁, b₂, and b₃ are mapped to a single 16-QAM symbol according to FIG. 4 that includes Gray coding. In the Gray code, in order to facilitate detection of any errors in the transmission, every two consecutive numbers differ in one digit only.

As indicated in FIG. 1, bits b₀ and b₁ belonging to stream A, that are encoded by encoder A, are mapped onto the I-channel, i.e. the real part, of the 16-QAM symbol. Bits b₂ and b₃ belonging to stream B, that are encoded by encoder B, are mapped onto the Q-channel, i.e. the imaginary part of the 16-QAM symbol.

To extract soft information values for the four bits b₀, b₁, b₂, and b₃ per each 16-QAM symbol, the log-likelihood ratio value based on posteriori probabilities (Gaussian hypothesis) is computed for each bit. This demapping operation generally involves exponential and logarithmic functions which are inconvenient for hardware implementation.

For a transmitted 16-QAM modulated symbol, y, the noisy complex 16-QAM symbol \tilde{y} received from the channel is expressed as:
\tilde{y}=hy+n

Where h is the complex channel coefficient, and n is the additive noise.

Embodiments of the invention include methods for estimating a transmitted 16-QAM modulated symbol using the following relationships. The following may be considered as approximations of the optimal soft demapping rules. Other embodiments of the invention include systems for implementing the following approximations in circuitry, for example in demap circuitry of a demapper:

$${L}_{0} = \frac{4 {z}_{re}}{\sqrt{10}} + \vert \frac{{z}_{re}}{\sqrt{10}} - c \vert - \vert \frac{{z}_{re}}{\sqrt{10}} + c \vert$$

as an estimate for bit b₀,

$${L}_{1} = - 2 \frac{\vert {z}_{re} \vert}{\sqrt{10}} + 2 c$$

as an estimate for bit b₁,

$${L}_{2} = \frac{4 {z}_{im}}{\sqrt{10}} + \vert \frac{{z}_{im}}{\sqrt{10}} - c \vert - \vert \frac{{z}_{im}}{\sqrt{10}} + c \vert$$

as an estimate for bit b₂, and

$${L}_{3} = - 2 \frac{\vert {z}_{im} \vert}{\sqrt{10}} + 2 c$$

as an estimate for bit b₃, with
zᵣₑ=2(\tilde{h}ᵣₑ\tilde{y}ᵣₑ+\tilde{h}ᵢₘ\tilde{y}ᵢₘ)
zᵢₘ=2(\tilde{h}ᵣₑ\tilde{y}ᵢₘ−\tilde{h}ᵢₘ\tilde{y}ᵣₑ)
and constant

$$c = \frac{2 {\vert \tilde{h} \vert}^{2}}{5}$$

Where \tilde{h}=\tilde{h}ᵣₑ+j\tilde{h}ᵢₘ is an estimate of the complex channel coefficient h as determined by the channel estimation unit based on the channel estimation sequence of a packet preamble of a packet of data.

Although the present invention has been described with reference to certain exemplary embodiments, it is understood that a variety of modifications and variations may be made to the present invention without departing from the spirit or scope of the invention defined in the appended claims, and their equivalents.

What is claimed is:

1. A method of determining soft bit estimates for transmitted symbols, comprising:
receiving a symbol over a communication channel; and
receiving an estimate of a channel coefficient for the communication channel;
determining an estimated value for bits of the received symbol by performing only additive and/or multiplicative operations using the received symbol and the estimate of the channel coefficient.

2. The method of claim 1, wherein determining the estimated value for bits of the received symbol comprises using the sum of a real portion of the channel estimate effectively multiplied with a real portion of the received symbol and an imaginary portion of the channel estimate effectively multiplied with an imaginary portion of the received symbol for bits representative of a real portion of the received symbol.

3. The method of claim 1, wherein determining the estimated value for bits of the received symbol comprises using the difference of a real portion of the channel estimate effectively multiplied with an imaginary portion of the received symbol and an imaginary portion of the channel estimate effectively multiplied with a real portion of the received symbol for bits representative of an imaginary portion of the received symbols.

4. The method of claim 1, wherein the received symbol is a 16-QAM symbol.

5. The method of claim 4, wherein determining the estimated value for bits of the received symbol comprises performing the operations of
$${L}_{0} = \frac{4 {z}_{re}}{\sqrt{10}} + \vert \frac{{z}_{re}}{\sqrt{10}} - c \vert - \vert \frac{{z}_{re}}{\sqrt{10}} + c \vert$$
as an estimate for a bit b₀,
$${L}_{1} = - 2 \frac{\vert {z}_{re} \vert}{\sqrt{10}} + 2 c$$
as an estimate for a bit b₁,
$${L}_{2} = \frac{4 {z}_{im}}{\sqrt{10}} + \vert \frac{{z}_{im}}{\sqrt{10}} - c \vert - \vert \frac{{z}_{im}}{\sqrt{10}} + c \vert$$
as an estimate for a bit b₂, and
$${L}_{3} = - 2 \frac{\vert {z}_{im} \vert}{\sqrt{10}} + 2 c$$
as an estimate for a bit b₃,
with
zᵣₑ=2(\tilde{h}ᵣₑ\tilde{y}ᵣₑ+\tilde{h}ᵢₘ\tilde{y}ᵢₘ)
zᵢₘ=2(\tilde{h}ᵣₑ\tilde{y}ᵢₘ−\tilde{h}ᵢₘ\tilde{y}ᵣₑ)
and
$$c = \frac{2 {\vert \tilde{h} \vert}^{2}}{5}$$
where
\tilde{h}=\tilde{h}ᵣₑ+j\tilde{h}ᵢₘ
\tilde{h} is an estimate of the channel coefficient and \tilde{y} is the received symbol.

6. The method of claim 1, wherein the received symbol is dual carrier modulation symbol.

7. The method of claim 6, wherein determining the estimated value for bits of the received symbol comprises performing the operations of
L₀=2z_{0,re}+|z_{1,re}−c|−|z_{1,re}+c|

as an estimate for bit b₀,
L₁=2z_{0,im}+|z_{1,im}−c|−|z_{1,im}+c|

as an estimate for bit b₁,
L₂=2z_{1,re}+|z_{0,re}−c|−|z_{0,re}+c|

as an estimate for bit b₂, and
L₃=2z_{1,im}+|z_{0,im}−c|−|z_{0,im}+c|

as an estimate for bit b₃,
with
z₀=(2\tilde{h}₀*\tilde{y}₀+\tilde{h}₁*\tilde{y}₁)/\sqrt{10}=z_{0,re}+jz_{0,im}
z₁=(\tilde{h}₀*\tilde{y}₀−2\tilde{h}₁*\tilde{y}₁)/\sqrt{10}=z_{1,re}+jz_{1,im}
and
$$c = \frac{{\vert {\tilde{h}}_{0} \vert}^{2} - {\vert {\tilde{h}}_{1} \vert}^{2}}{5}$$
\tilde{h} is an estimate of the channel coefficient and \tilde{y} is the received symbol.

8. A demapper for extracting soft information regarding transmitted bits per each DCM symbol transmitted over a noisy channel from received noisy complex symbols, the demapper comprising demapper circuitry for developing:
estimates of complex channel coefficients, and
estimates of the transmitted bits based on the estimates of complex channel coefficients and the received noisy complex symbols,
wherein the demapper circuitry implements division-free operations, and
wherein an estimate of the DCM symbol is obtained from the estimates of the transmitted bits.

9. A demapper for extracting soft information regarding transmitted bits per each 16-QAM symbol transmitted over a noisy channel from received noisy complex symbols, the demapper comprising demapper circuitry for developing:
estimates of complex channel coefficients, and
estimates of the transmitted bits based on the complex channel coefficients and the received noisy complex symbols,
wherein the demapper circuitry implements division-free operations, and
wherein an estimate of the 16-QAM symbol is obtained from the estimates of the transmitted bits.

10. A method for extracting soft estimates of bits b0, b1, b2, and b3 per each transmitted DCM symbol from a received first noisy symbol and a received second noisy symbol, the transmitted DCM symbol transmitted over a noisy channel and received at a receiver, the transmitted DCM symbol including a first 16-QAM transmitted symbol, and a second 16-QAM transmitted symbol, the first noisy symbol being a noisy estimate of the first 16-QAM transmitted symbol and the second noisy symbol being a noisy estimate of the second 16-QAM transmitted symbol, the first 16-QAM transmitted symbol and the second 16-QAM transmitted symbol being related to the bits b0, b1, b2, and b3 through x0=2b0−1, x1=2b1−1, x2=2b2−1, and x3=2b3−1, according to relationships:
$$first \text{16-} \text{QAM} transmitted symbol = ( 1 / √ 10 ) * [ 2 ( x 0 + j x 1 ) + 1 ( x 2 + j x 3 ) ] = ( 1 / √ 10 ) * [ ( 2 x 0 + x 2 ) + j ( 2 x 1 + x 3 ) ] , and$$
$$second \text{16-} \text{QAM} transmitted symbol = ( 1 / √ 10 ) * [ 1 ( x 0 + j x 1 ) - 2 ( x 2 + j x 3 ) ] = ( 1 / √ 10 ) * [ ( x 0 - 2 x 2 ) + j ( x 1 - 2 x 3 ) ] ,$$
the method comprising:
determining estimates of a first complex channel coefficient and a second complex channel coefficient, as a first estimate, and a second estimate, respectively, the first estimate and the second estimate being determined based on channel estimation sequence of packet preamble of a packet of data received at the receiver;
determining a constant c according to a relationship c=[(magnitude of first estimate)ˆ2−(magnitude of second estimate)ˆ2]/[5];
obtaining a first conjugate, and a second conjugate, respectively as a complex conjugate of the first estimate and a complex conjugate of the second estimate;
determining a first intermediate variable z0 according to a relationship z0=[2*first conjugate*first noisy symbol+second conjugate*second noisy symbol]/[sqrt(10)];
determining a second intermediate variable z1 according to a relationship z1=[first conjugate*first noisy symbol−2*second conjugate*second noisy symbol]/[sqrt(10)];
representing the z0 and the z1, as z0=z0real+jz0imaginary and z1=z1real+jz1imaginary;
obtaining L0, L1, L2, and L3 as estimates of the four transmitted bits b0, b1, b2, and b3, respectively, according to relationships:
L0=2z0real+absolute value of (z1real−c)−absolute value of (z1real+c),
L1=2z0imaginary+magnitude of (z1imaginary−c)−magnitude of (z1imaginary+c),
L2=2z1real+absolute value of (z0imaginary−c)−absolute value of (z0imaginary+c), and
L3=2z1imaginary+magnitude of (z0imaginary−c)−magnitude of (z0imaginary+c); and
determining soft estimates of the first 16-QAM transmitted symbol and the second 16-QAM transmitted symbol by using the L0, L1, L2, and L3 according to relationships:
xp0=2L0−1, xp1=2L1−l, xp2=2L2−1, and xp3=2L3−1,
estimate of the first 16-QAM transmitted symbol=(1/√10)*[2(xp0+jxp1)+1(xp2+jxp3)]=(1/√10)*[(2xp0+xp2)+j(2xp 1+xp3)], and
estimate of the second 16-QAM transmitted symbol=(1/√10)*[1(xp0+jxp1)−2(xp2+jxp3)]=(1/√10)*[(xp0−2xp2)+j(xp1−2xp3)].

11. A method for extracting soft estimates of bits b0, b1, b2, and b3 per each 16-QAM symbol transmitted over a noisy channel at a receiver from a received noisy symbol, the method comprising:
determining a channel estimate as an estimate of a complex channel coefficient, based on channel estimation sequence of packet preamble of a packet of data received at the receiver;
determining a constant c according to a relationship c=2*[(magnitude of the channel estimate)ˆ2]/[5];.
determining an intermediate variable z=zreal+j*zimaginary according to a relationship zreal=2*[real part of the channel estimate*real part of the noisy symbol+imaginary part of the channel estimate*imaginary part of the noisy symbol], and zimaginary=2*[real part of the channel estimate*imaginary part of the noisy symbol−imaginary part of the channel estimate*real part of the noisy symbol];
determining L0, L1, L2, and L3 as estimates of the bits b0, b1, b2, and b3, respectively, according to relationships:
L0=4*zreal/sqrt(10)+absolute value of [zreal/(sqrt(10)−c]−absolute value of [zreal/sqrt(10)+c],
L1=−2*absolute value of [zreal]/sqrt(10)+2*c,
L2=4*zimaginary/sqrt(10)+absolute value of [zimaginary/sqrt(10)−c]−absolute value of [zimaginary/sqrt(10)+c], and
L3==−2*absolute value of [zimaginary]/sqrt(10)+2*c; and
determining an estimate of the y by using the L0, L1, L2, and L3 instead of the bits b0, b1, b2, and b3 in the relationship yielding the y from the bits b0, b1, b2, and b3.
